(19) United States
(12) Patent Application Publication
(10) Pub. No.: US 2008/0127356 A1
(43) Pub. Date: May 29, 2008

(54) EMBEDDED SYSTEMS AND METHODS FOR SECURING FIRMWARE THEREIN

(75) Inventors: Chi-Chun Hsu, Hsinchu City (TW); Yuh-Long Yeh, Taipei City (TW); Ming-Yang Chao, Hsin-Chu Hsien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/563,233

(22) Filed: Nov. 27, 2006

(51) Int. Cl. G06F 12/14

(52) U.S. Cl. 726/30

(57) ABSTRACT

A method for securing firmware in a memory is provided. Memory data in the memory is checked. If the memory data in the memory meets a criterion, a host is allowed to read and write the entire memory. If not, the host is prevented from reading the entire memory.

### BACKGROUND OF THE INVENTION

1. Field of the Invention

The invention relates to embedded systems, and in particular to embedded systems and methods for securing firmware therein.

2. Description of the Related Art

Video game consoles, such as PS2™ or Xbox™, are embedded systems with firmware stored in the embedded memory thereof controlling operations. The firmware contains code directing, for example, identification of authorized source CD-ROM. Such firmware is secured against unauthorized alteration and update, to prevent use of non-proprietary source discs.

Generally, in order to enable embedded memory update when there is no firmware therein, an extra path, such as an IDE path or an SIO path, is provided. Through this extra path, a host, such as a personal computer, can update/write firmware to an embedded memory irrespective of the presence of an existing version. However, the extra path exposes the firmware to possible intrusion.

One solution to the problem is to require password entry before allowing access to the extra path. If an input password matches a verification code in an integrated circuit (IC) of the embedded system, the extra path allows access to firmware therein. If the verification code is implemented by hardwiring on an IC, all users share the same verification code, presenting a security problem. A set of electronic fuses added into an IC, while allowing creation of a unique verification code, increase costs due not only increased area required by the electronic fuses but also the requirement for a specific manufacturing flow.

### BRIEF SUMMARY OF THE INVENTION

A method for securing firmware in a memory according to embodiments of the invention is provided. Memory data in the memory is checked. If the memory data in the memory meets a criterion, reading and writing of the entire memory is permitted.

A memory module according to embodiments of the invention is provided. The memory module comprises a memory, a memory check module, and a download module. The memory check module is connected to the memory, checking memory data in the memory. An enable signal is asserted if the memory data meets a criterion and the enable signal is deasserted if the memory data does not meet the criterion. The download module is connected between the memory and a host, allowing the host to read and write to the entire memory if the enable signal is asserted and disabling read of at least a portion of the memory if the enable signal is deasserted.

A firmware update method according to embodiments of the invention is provided. Original data is written to an embedded memory through a download path from a host to the embedded memory. A written portion of the embedded memory is then read. A verification result according to data read from the embedded memory is generated to the host. The verification result contains information less than data read. The host cannot read the written portion of the embedded memory, and depends on the verification result for writing evaluation.

A firmware update system according to embodiments of the invention is provided, comprising an embedded memory, a download module and a verification module. The download module is connected between a host and the embedded memory, providing a download path for the host to write original data into the embedded memory. The verification module reads a written portion of the embedded memory and generates a verification result to the host according to data read from the written portion. The verification result contains information less than data read. The host is unable to read the written portion of the embedded memory and relies on the verification result for writing evaluation.

A detailed description is given in the following embodiments with reference to the accompanying drawings.

### BRIEF DESCRIPTION OF DRAWINGS

The invention can be more fully understood by reading the subsequent detailed description and examples with reference made to the accompanying drawings, wherein:

FIGS. 1 and 2 are functional block diagrams of an embedded system and a host connected by standard interface according to embodiments of the invention.

### DETAILED DESCRIPTION OF THE INVENTION

The following description is of the best-contemplated mode of carrying out the invention. This description is made for the purpose of illustrating the general principles of the invention and is determined to not be taken in a limiting sense. The scope of the invention is best determined by reference to the appended claims.

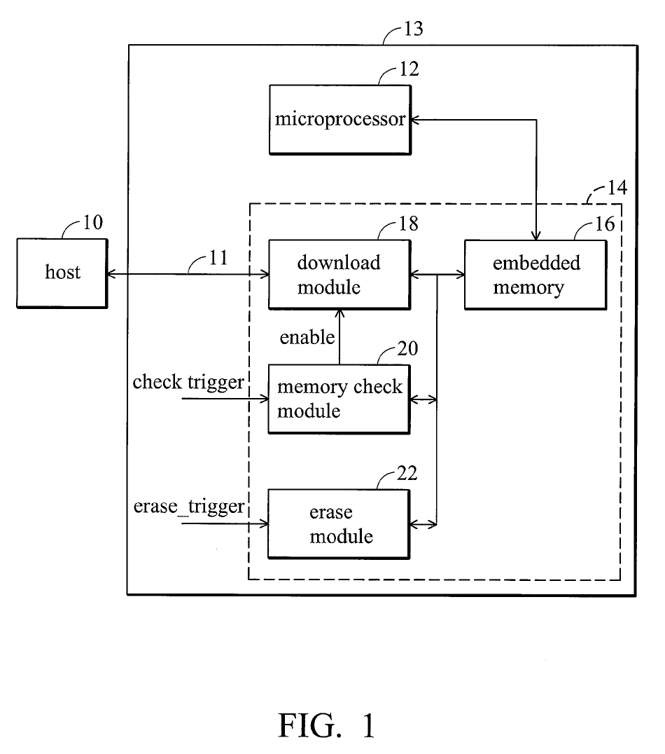

FIG. 1 is a functional block diagram of an embedded system and a host connected by standard interface according to embodiments of the invention. The host 10 may be a personal computer. Standard interface 11 can be an IDE bus or an SIO bus. Embedded system 13 comprises a microprocessor 12 and memory module 14 including download module 18, embedded memory 16, memory check module 20 and erase module 22. Embedded memory 16 may be a serial or parallel flash memory storing firmware that microprocessor 12 operates accordingly. Embedded memory 16 may be embedded in a Multi-Chip Module (MCM) or in a system-on-chip (SOC) design. Download module 18 and memory check module 20 together form a gate guard to determine whether the memory data in the embedded memory 16 can be released to host 10. Erase module 22 can erase the memory data in the embedded memory upon an erase_trigger signal.

An embodiment of the invention prevents the release of the memory data in embedded memory 16 to host 10 if embedded memory 16 is not “empty”. Embedded memory 16 is presumed not to be empty if the memory data does not meet a criterion. For example, if the memory data is all 0s or all is, embedded memory 16 is determined to be empty because firmware generally includes code with 0s and 1s mixed together. In other words, if the memory data has a predetermined pattern, it may be determined to be empty. Other methods of determination are possible. For example, if the memory data is concluded to have a cyclic redundancy check (CRC) the same as a predetermined result, embedded memory 16 is presumed to be empty.

Accordingly, memory check module 20 checks the memory data in embedded memory 16 before allowing host 10 to read and write the entire embedded memory 16, and determines whether the memory data is empty, based on criteria described. Memory check module 20 may check the entire memory data therein or only a portion thereof. If the memory data meets a criterion, the memory data is determined to be empty and memory check module 20 asserts an enable signal such that download module 18 provides a download path between host 10 and embedded memory 16. If not, the memory data is determined to not be empty and memory check module 20 deasserts the enable signal such that download module 18 deactivates the download path and host 10 cannot read the memory data in embedded memory 16.

Triggering of memory check module 20 to check the memory data in embedded memory 16 occurs before allowing host 10 to read and write the entire embedded memory 16. For example, triggering memory check module to check may occur when embedded system 13 including memory module 14 is powered up, so the enable signal from memory check module 20 remains either asserted or deasserted after power on. Alternatively or additionally, it may occur every time host 10 attempts to update embedded memory 16 by sending a check trigger signal to memory check module 20.

Deactivating the download path between host 10 and embedded memory 16 prevents host 10 from reading at least a portion of embedded memory 16, such that the entirety of memory data, which may be official firmware, remains unrevealed. Under the deactivation of the download path, at least a portion of embedded memory 16 cannot be read by host 10. In other words, under the deactivation of the download path, host 10 may not read any portion of embedded memory 16, may read only a portion of embedded memory 16, or may read only a logic result calculated from the memory data in embedded memory 16. Embedded memory 16 may be capable of being written by host 10 under this circumstance.

As mentioned, a predetermined pattern may be used as a criterion to determine whether embedded memory 16 is empty. Embedded memory 16 can be emptied to have default data with the predetermined pattern during a test stage before assembling embedded memory 16 into embedded system 13. By doing so, memory check module 20 activates the download path and host 10 can write new firmware into embedded memory 16.

Firmware in embedded memory 16 may contain faulty code, requiring updating. Erase module 22 thus provides a way to update the firmware in embedded memory when embedded memory 16 is determined not to be empty. Based on an erase_trigger signal from host 10, erase module 22 allows erasing of embedded memory 16 and further renders the memory data in embedded memory 16 determinable as “empty”. Since embedded memory 16 has become empty, memory check module 20 activates the download path and host 10 can write and read the entire embedded memory 16 to update the firmware therein. Thus, irrespective of whether erased memory data is healthy or defective firmware, it has been erased and cannot be accessed by host 10 through the standard interface 11.

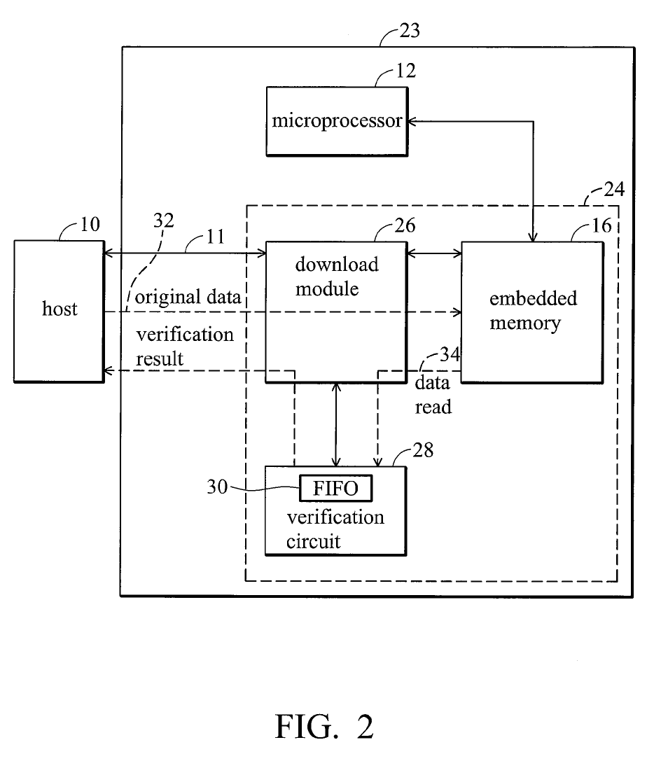

As is known, for a host connected to an embedded system, writing original data to embedded memory is generally followed by reading written data from the embedded memory to verify consistency between the original data and the written data and to determine successful writing. Read capability also exposes firmware in an embedded memory. The embodiment in FIG. 2 redirects a readout path, providing a verification result to a host, securing the data in the embedded memory.

FIG. 2 is another functional block diagram of an embedded system and a host connected by standard interface according to embodiments of the invention. Embedded system 23 comprises a microprocessor 12 and memory module 24 includes download module 26, embedded memory 16, and verification module 28. The same symbols used in FIGS. 1 and 2 refer to the same functional elements and are not detailed hereinafter.

Download module 26 and verification module 28 together form a gate guard to redirect a readout path and provide a verification result to a host. As shown in FIG. 2, host 10 can write original data to embedded memory 16 through a writing path consisting of standard interface 11, download module 26 and the bus between download module 26 and embedded memory 16. Download module 26, between host 10 and embedded memory 16, prevents host 10 from reading the portion of embedded memory 16 to which host 10 has recently written data. Rather, readout path 34 is redirected to verification module 28, reading the written portion of embedded memory 16 and generating a verification result to host 10 according to data read from embedded memory 16. Host 10 relies on the verification result for writing evaluation. For example, if the verification result is determined to be positive, host 10 determines previous data writing to be successful and writes the next data to embedded memory 16.

To maintain security of memory data in embedded memory 16, the verification result must contain information less than data read. For example, the verification result may be data read after removing certain bits or bytes therein, a redundancy check of data read (such as a CRC), a logic calculation result from data read, or the like. Receiving the verification result from verification module 28 and knowing the data manipulation in verification module 28 together with the expected data read, host 10 can thus generate an expected verification result for comparison with a received verification result and evaluate whether a previous writing is successful. Alternatively, writing evaluation can be accomplished in verification module 28. As shown in FIG. 2, verification module 28 has a first-in-first-out (FIFO) 30 as a buffer to buffer original data written to embedded memory 16. This FIFO 30 can be the cache of the original data to speed the writing procedure. By comparing data read from embedded memory 16 with the original data in the buffer (expected to be the same), verification module 28 can evaluate whether a previous writing is successful and accordingly inform host 10 by asserting or deasserting a success signal as a verification result. Host 10 cannot obtain data read but depends on the verification result for writing evaluation.

Embedded memory 16 can be replaced by a commodity memory IC that itself alone is packaged. Here in the specification and claims, a memory refers to, but is not limited to, an embedded memory or a commodity memory IC.

Embodiments of the invention as exemplified in FIGS. 1 and 2 provide a gate guard between a host and an embedded memory to ensure firmware in the embedded memory cannot be read out by the host. The implementation of the embodiments is compatible with conventional integrated circuit manufacturing and requires minimal extra silicon area. Embodiments of the invention secure firmware in an embedded memory more efficiently and at lower cost than the conventional technology.

While the invention has been described by way of examples and in terms of preferred embodiment, it is to be understood that the invention is not limited to thereto. To the contrary, it is intended to cover various modifications and similar arrangements (as would be apparent to those skilled in the art). Therefore, the scope of the appended claims is determined to be accorded the broadest interpretation so as to encompass all such modifications and similar arrangements.

What is claimed is:

1. A method for securing firmware in a memory, comprising:
checking memory data in the memory;
allowing a host to read and write the entire memory if the memory data in the memory meets a criterion; and
preventing the host from reading at least a portion of the memory if the memory data in the memory does not meet the criterion.

2. The method of claim 1, further comprising erasing the memory to make the memory data in the memory meet the criterion.

3. The method of claim 1, wherein the memory is a serial or parallel flash memory.

4. The method of claim 1, wherein a download path for the host to read and write the entire memory comprises an IDE bus or an SIO bus.

5. The method of claim 1, wherein the memory data is checked by computing the cyclic redundancy check (CRC) of the memory data and the criterion is that the CRC is the same as a predetermined result.

6. The method of claim 1, wherein the criterion is that the memory data in the memory is all 0 or all 1.

7. The method of claim 1, wherein the criterion is that the memory data has a predetermined pattern.

8. The method of claim 7, further comprising writing default data with the predetermined pattern into the memory during a test stage.

9. The method of claim 1, wherein the download path is deactivated by allowing the host to read only a portion of the memory or preventing the host from reading any of the memory, such that at least a portion of the memory cannot be read through the download path by the host.

10. A memory module, comprising:
a memory storing memory data;
a memory check module connected to the memory, checking the memory data, wherein an enable signal is asserted if the memory data meets a criterion and the enable signal is deasserted if the memory data does not meet the criterion; and
a download module connected between the memory and a host, allowing the host to read and write the entire memory if the enable signal is asserted and preventing the host from reading the entire memory if the enable signal is deasserted.

11. The memory module of claim 10, wherein the memory check module is triggered when the memory module is powered up or when the host attempts to update the memory.

12. The memory module of claim 10, wherein the memory check module checks the memory data by computing the cyclic redundancy check (CRC) of the memory data.

13. The memory module of claim 10, wherein the memory is written with default data having the predetermined pattern during a test stage.

14. The memory module of claim 10, further comprising an erase module erasing the memory and making the memory data in the memory meet the criterion.

15. The memory module of claim 10, wherein the memory check module checks at least a portion of the memory data.

16. The memory module of claim 10, wherein if the enable signal is deasserted, the download module disallows the host to read any of the memory.

17. A firmware update method, comprising:
writing original data to an embedded memory through a download path from a host to the embedded memory;
reading a written portion of the embedded memory; and
generating a verification result to the host according to data read from the embedded memory;
wherein the verification result contains information less than the data read, the host cannot read the written portion of the embedded memory, and the host depends on the verification result for writing evaluation.

18. The firmware update method of claim 17, comprising:
buffering the original data in a buffer; and
comparing the original data in the buffer with data read to generate the verification result.

19. The firmware update method of claim 18, wherein the buffer is a first-in-first-out (FIFO).

20. A firmware update system, comprising:
an embedded memory;
a download module, connected between a host and the embedded memory, providing a download path for the host to write original data into the embedded memory; and
a verification module, reading a written portion of the embedded memory and generating a verification result to the host according to data read from the written portion;
wherein the verification result contains information less than the data read, the host is unable to read the written portion of the embedded memory and the host relies on the verification result for writing evaluation.
